(19) United States
(12) Patent Application Publication
(10) Pub. No.: US 2021/0216340 A1
(43) Pub. Date: Jul. 15, 2021

(54) JAVASCRIPT ENVIRONMENT INITIALIZATION

(71) Applicant: Hewlett-Packard Development Company, L.P., Spring, TX (US)

(72) Inventor: Christoph Graham, Spring, TX (US)

(73) Assignee: Hewlett-Packard Development Company, L.P., Spring, TX (US)

(21) Appl. No.: 17/046,855

(22) PCT Filed: Sep. 27, 2018
(86) PCT No.: PCT/US18/53036

§ 371 Date: Oct. 12, 2020

(51) Int. Cl. G06F 9/455; G06F 11/36; G06F 11/30; G06F 8/41

(52) U.S. Cl. CPC G06F 9/45529; G06F 9/45508; G06F 8/41; G06F 11/301; G06F 11/3656

(57) ABSTRACT

Examples associated with JavaScript environment initialization are described. One example includes initializing a portion of a JavaScript virtual machine (JSVM) to a point at which the portion of the JSVM has a known consistent state. This creates a JavaScript environment (JSE). A request is received for an asset that incorporates the JSE. The request is received from an application. The JSE is transmitted to the application

### BACKGROUND

The demand for web-based applications and services has increased over time. This is especially true due to the shift from providing users applications they run on their computers to applications run in the cloud and/or within browsers. The growth in use cases and functionality of web-based applications has led applications to rely on frameworks and libraries to extend the functionality of the applications. For example, in web browsers, a significant amount of the browser may be dedicated to loading JavaScript components of web-based applications. These components may add functionality such as layout rendering, data management and manipulation, application functionality, user experience, and so forth.

### BRIEF DESCRIPTION OF THE DRAWINGS

The present application may be more fully appreciated in connection with the following detailed description taken in conjunction with the accompanying drawings.

FIG. 1 illustrates an example host associated with JavaScript environment initialization.

FIG. 2 illustrates a flowchart of example operations associated with JavaScript environment initialization.

FIG. 3 illustrates another flowchart of example operations associated with JavaScript environment initialization.

FIG. 4 illustrates an example system associated with JavaScript environment initialization.

FIG. 5 illustrates another flowchart of example operations associated with JavaScript environment initialization.

FIG. 6 illustrates an example computing device in which example systems, and methods, and equivalents, may operate.

### DETAILED DESCRIPTION

Examples associated with JavaScript environment initialization are described. As discussed above, the increased use of web-based applications has led to an increase in the variety of applications in capability and function. This has also lead to an increase in the size and complexity of these applications. In some cases, the size and complexity of the applications may make it so that even with optimizations, the applications use a substantial amount of resources, take a long time to load, and so forth. This has led to an increased usage of a just-in-time programming model that tries to complete optimizations just as resources are being used. However, this may still be inefficient for complex applications.

Instead, techniques disclosed herein relate to pre-compiling and pre-optimizing portions of a JavaScript virtual machine (JSVM) that frequently reach a consistent execution state at some point during their use. These pre-optimized portions may then be injected as requested into a JSVM that is also compiling and optimizing other portions of the JSVM that, for example, reach different execution states dependent on inputs. The preoptimized portions may include compiled and optimized code, memory and state information, and so forth such that the pre-optimized portion is ready to begin operation in the JSVM without additional preprocessing.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, instructions stored on a computer-readable medium or in execution on a machine, and/or combinations of each to perform a function(s) or an action(s), and/or to cause a function or action from another module, method, and/or system. A module may include a microprocessor controlled via instructions executable by the microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

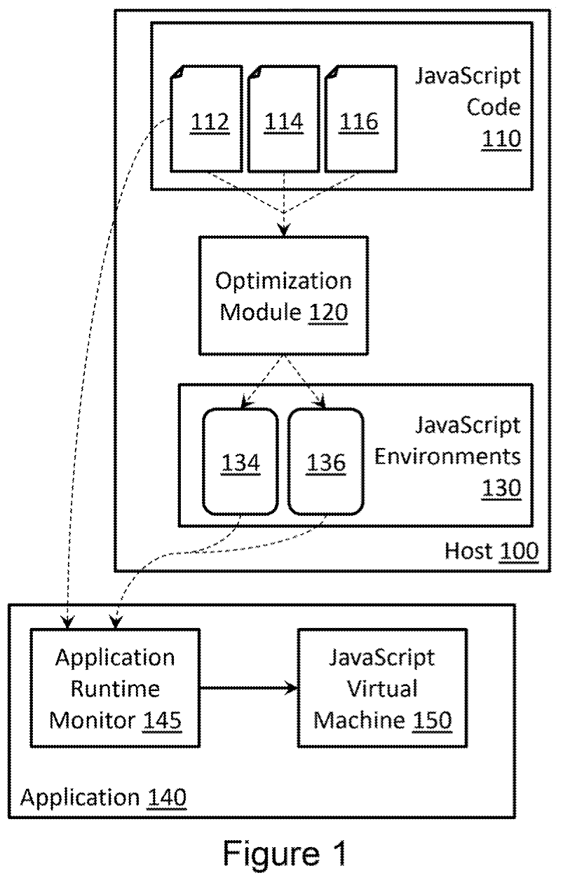

FIG. 1 illustrates an example host 100 associated with JavaScript environment initialization. In various examples, host 100 may be responsible for delivering content requested by an application 140. By way of illustration, application 140 may be a web browser, and host 100 may be a server on which content being requested by application 140 is located. While an example of a web browser and server is used to facilitate discussion of FIG. 1, it should be appreciated that other applications 140 may incorporate JSVMs 150, and therefore techniques disclosed herein may have applicability for other non-web browser types of applications 140. Further, host 100 may not be remote to application 140, as in certain examples a certain device may perform the roles of both host 100 and application 140.

In various examples, JSVM 150 may be associated with performing some function that is to be incorporated into or displayed by application 140. As will be appreciated, a JSVM 150 may be designed to perform a wide variety of functions because JavaScript is a core technology of the Internet that is often used to facilitate interactivity in web pages. To that end, most web browsers have a dedicated runtime monitor 145 to compile and optimize received JavaScript code 110 and execute it as JSVM 150. JavaScript is used, for example, for gaming, productivity, user interface support, performing data analysis, and so forth.

When application 140 requests a resource from host 100 that involves JSVM 150, host 100 will typically transmit portions of JavaScript code 110 used to build JSVM 150. Application 140 may then provide the code portions to application runtime monitor 145. Application runtime monitor 145 will then perform a variety of tasks on the JavaScript code 110 to generate JSVM 150. These tasks may include, for example, compiling the JavaScript code 110 into instructions interpretable by a processor of a device operating application 140, optimizing the code, and so forth. For examples where the amount JavaScript Code 110 needed to generate JSVM 150 is relatively small, application runtime monitor 145 may be able to compile, optimize, and control execution of the entirety of JSVM 150. However, performing a single pass optimization of a relatively larger sets of JavaScript code 110 may be slower due to the increasing complexity and length of the code base resulting from the expanding functionalities of embedded JSVMs 150. This is especially true when the JSVMs are being used to perform data analysis on big data sets, involve complex graphics or interactivity, and so forth as these tasks may invoke specialized libraries and/or frameworks for performing these tasks. Some example specialized libraries may include, for example, JQuery, AngularJS, React, Vue.JS, D3.JS, High harts, and so forth. In the cases where it is less feasible to compile and optimize an entire JSVM 150 at once, application runtime monitors 145 have begun to build efficiency by compiling and/or optimizing portions of JavaScript Code 110 either just in time or as they are requested by other portions of already executing JSVM 150. However, this may still be inefficient as building the portions as needed may slow down execution of JSVM 150 if those portions take time to compile and optimize.

Consequently, techniques disclosed herein may provide faster building and execution of JSVMs 150 by application 140. This may be achieved by generating JavaScript environments (JSE) 130 and injecting the JSEs into JSVM 150 by application runtime monitor 145. The JSEs 130 may be generated by optimization module 120. To build the JSEs, optimization module 120 may effectively act as an application runtime monitor 145 and build JSVM 150 several times with the goal of identifying portions of JavaScript code 110 that optimize to a consistent state. In some examples, optimization module 120 may build JSVM 150 using a variety of input sets to further identification of portions of JavaScript code 110 that optimize to a consistent state. When portions of JavaScript code 110 that optimize to a consistent state are identified, optimization module 120 may store the portions as JSEs 130 in host 100. The JSEs 130 may include executable code, and other state information including initialized variables and other memory information. Effectively, the stored JSEs 130 may be a binary representation of an application state of a corresponding portion of JavaScript code 110. The application state may then either be replayed in the future, using the preserved optimizations, or transferred to a JSVM 150 on another device and executed from the preserved state.

By way of illustration, in this example, host 100 stores three portions of JavaScript code 110 including portion 112, portion 114, and portion 116 that are associated with building JSVM 150. These portions may be fed to optimization module 120 that identifies that portions 114 and 116 optimize to a consistent state. Optimization may then store JSE versions 134 and 136 of code portions 114 and 116 respectively. As portion 112 may not optimize to a consistent state (e.g., because its optimizations are dependent on factors that change between executions), optimization module 120 may not store a JSE 130 for code portion 112. When application 140 requests an asset associated with JSVM 150, host 100 may look to see if JSEs 130 have been created for the portions of JavaScript code 110 associated with JSVM 110. For code portions which are not associated with a JSE 130 (e.g., portion 112) host 100 may transmit those portions as JavaScript code to application 140 to be built and executed as would have been done previously by application runtime monitor 145. However, for portions of JavaScript code 110 for which a JSE 130 exists (e.g., portion 114, portion 116), hosts 100 may instead transmit the JSEs 130 (e.g., JSE 134, JSE 136). Consequently, instead of building the code portions from scratch, application runtime monitor 145 may inject the pre-built and pre-initialized JSEs at the appropriate point in time, saving application runtime monitor 145 from having to optimize these portions itself.

Injecting a JSE 130 into the JSVM 150 may include inserting into a memory associated with JSVM 150, portions of the JSE 130 in such a way that the JSVM 150 operates as if the JavaScript code 110 associated with the JSE 130 had been compiled and optimized by runtime monitor 145. This may include inserting instructions associated with the JSE 130 into memory, updating memory values and/or locations to pre-initialized values associated with JSE 130, and so forth.

It should be appreciated however, that the ability to inject a JSE 130 into other JavaScript code to facilitate building a JSVM 150 may not be allowed by certain applications 140 and/or application runtime monitors 145. To that end, host 100 may also store an application runtime monitor 145 that supports this functionality and provide runtime monitor 145 to application 140 when appropriate. In other examples, application runtime monitor 145 may be able to be controlled to inject the JSEs 130 using debugging hooks that are native to the JSE 130. Eventually, native runtime monitors may be designed to support injection of JSEs 130 into JSVMs 150. To prevent injection of malicious code using techniques described herein, host 100 and application 140 may also negotiate code signing based on trusted authorities to ensure that code in execution is secure and will not harm a device on which application 140 is operating.

Pre-building and injecting JSEs 130 into a JSVM 150 may speed up the optimization process associated with executing a JSVM. This may be because application runtime monitor 145 does not have to go through the process of compiling and optimizing JavaScript code portions 110 when initializing the JSVM 150. Additionally, because JSVMs may be recreated several times due to, for example, reloading a webpage, having the JSE's ready in advance may allow the JSVM 150 to be reloaded without having to repeat the compiling and optimization process.

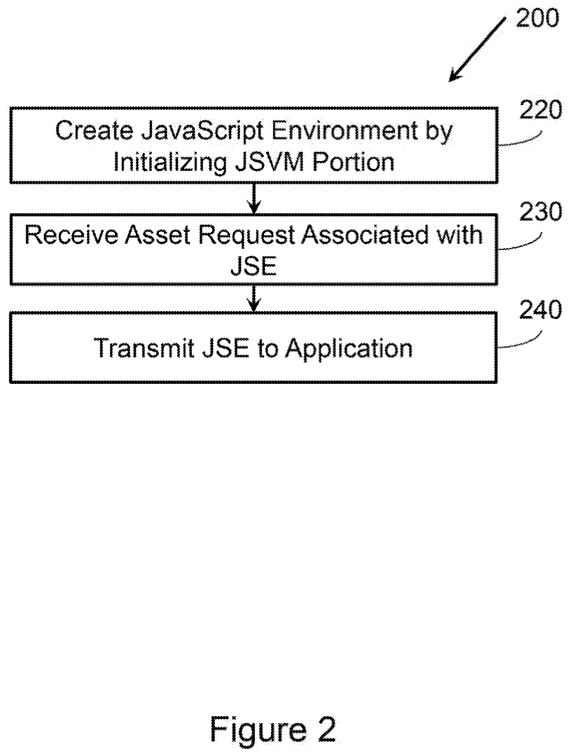

FIG. 2 illustrates an example method 200. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 may perform various tasks associated with JavaScript environment initialization. For example, method 200 includes creating a JavaScript environment (JSE) at 220. The JSE may be created by initializing a portion of a JavaScnpt virtual machine (JSVM). The JSVM may be initialized to a point at which the portion of the JSVM has a known consistent state. In some examples, the JSE may include a binary image of a state of the portion of the JSVM. Thus, the JSE may include compiled and optimized code, initialized variables, and so forth.

Method 200 also includes receiving a request for an asset at 230. The asset may incorporate the JSVM. The request may be received from an application. The application may be, for example, a web page.

Method 200 also includes transmitting the JSE to the application at 240. This may allow the application to inject the JSE into a version of the JSVM that the application is building.

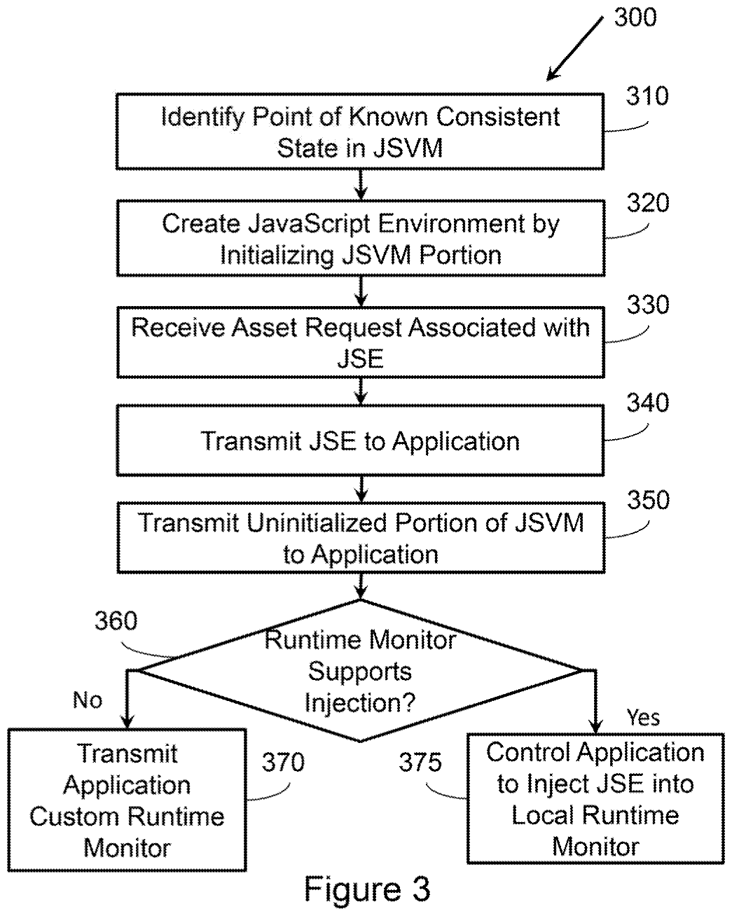

FIG. 3 illustrates a method 300 associated with JavaScript environment initialization. Method 300 includes several actions similar to those described above with reference to method 200 (FIG. 2). For example, method 300 includes creating a JavaScript environment (JSE) at 320 from a portion of a JavaScript virtual machine (JSVM), receiving an asset request from an application at 330, and transmitting the JSE to the application at 340.

Method 300 also includes identifying a point at which the portion of the JSVM has a known consistent state at 310. This may be achieved by repeatedly compiling and executing the portion of the JSVM.

Method 300 also includes transmitting an uninitialized portion of the JSVM to the application at 350. The uninitialized portion of the JSVM may be compiled and optimized by a runtime monitor initiated by the application. The application may then incorporate the uninitialized portion and the initialized portion to perform a function.

To incorporate the uninitialized portion and the initialized portion together, the application may need to use a runtime monitor that supports injecting the JSE into a portion of code that the application has compiled and optimized itself. In some examples, the application may use a runtime monitor to compile and build JavaScript code to perform a function. If it is determined at 360 that a runtime monitor available to the application supports injection of the JSE, method 300 may include controlling the application to inject the initialized JSE into the local runtime monitor at 375. This may use an interface of the local runtime monitor, which may facilitate injection of certain types of compiled code via debugging hooks. In other examples, a runtime monitor that supports injection of the initialized JSE may need to be provided to the application, in which case method 300 may proceed to action 370 and transmit the application a custom runtime monitor.

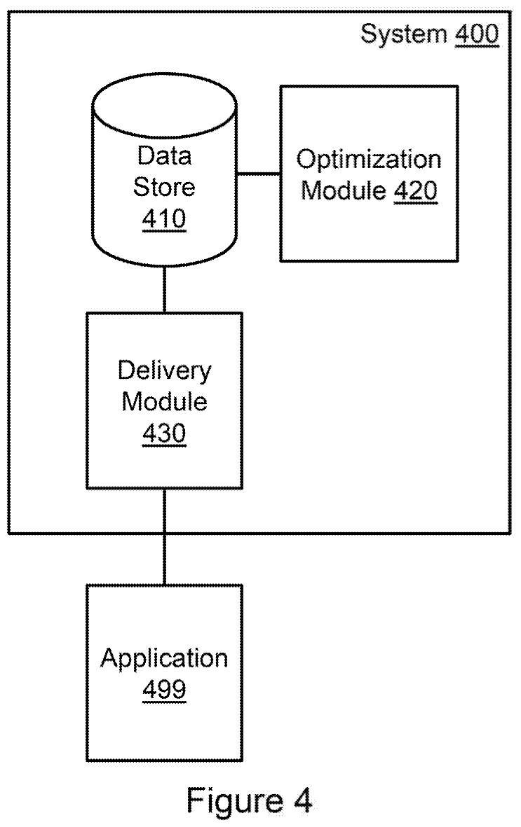

FIG. 4 illustrates a system 400. System 400 includes a data store 410. Data store 410 may store a set of uncompiled portions of a JavaScript virtual machine (JSVM).

System 400 also includes an optimization module 420. Optimization module 420 may build portions of the JSVM to identify portions of the JSVM that optimize to a consistent state. A portion that optimizes to a consistent state may be a portion that reaches a reproducible execution point for different input sets for the JSVM. Optimization module 420 may also store initialized versions of the portions of the JSVM that optimize to consistent states. These initialized versions may be stored as JavaScript environments (JSEs). The JSEs may be stored in data store 410.

System 400 also includes a delivery module 430. Delivery module 430 may receive a request for an asset associated with the JSVM from an application 499. Application 499 may be, for example, a web browser. In response to the request, delivery module 430 may deliver portions of the JSVM to a runtime monitor associated with application 499. For portions of the JSVM that are not associated with a JSE in data store 410, delivery module 430 may deliver uncompiled versions of these portions. For portions of the JSVM that are associated with a JSE, delivery module 430 may the corresponding JSE.

In some examples, delivery module 430 may also control application 499 to use debugging hooks of a runtime monitor native to application 499 to inject the JSEs at appropriate locations of the JSVM. In other examples, delivery module 430 may also deliver the runtime module to application 499. In these examples, the runtime monitor delivered to the application may support injecting the JSEs at appropriate locations of the JSVM.

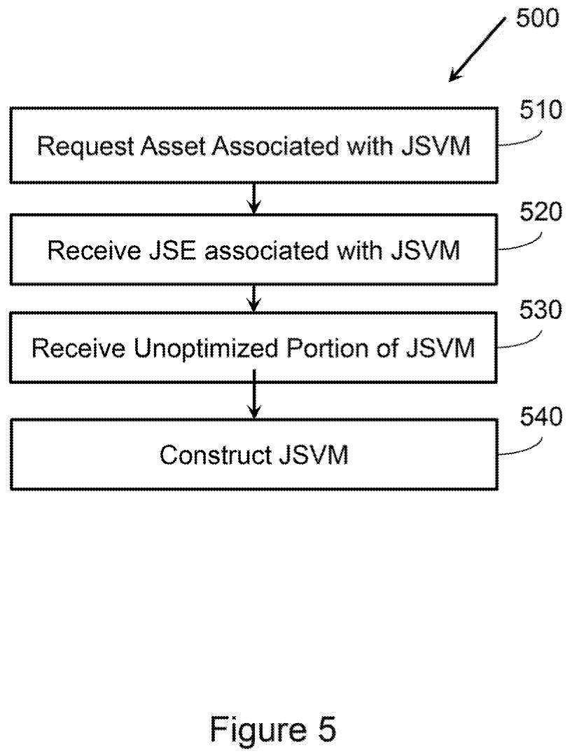

FIG. 5 illustrates a method 500 associated with JavaScript environment initialization. Method 500 includes requesting an asset associated with a JavaScript virtual machine (JSVM) at 510.

Method 500 also includes receiving a JavaScript environment (JSE) associated with a portion of the JSVM at 520. The JSE may be associated with instructions that reach a reproducible execution point when compiled and optimized, despite different input sets for the JSVM. The JSE may include, for example, an initialized binary image of a state of the portion of the JSVM.

Method 500 also includes receiving an unoptimized portion of the JSVM at 530. Method 500 also includes constructing the JSVM at 540. The JSVM may be constructed by compiling and optimizing the unoptimized portion of the JSVM, and injecting the JSE at an appropriate point in the JSVM. In some examples, the JSE may be injected using debugging hooks associated with a native runtime monitor. In other examples, method 500 may include receiving a runtime monitor that supports injecting the JSE into the JSVM.

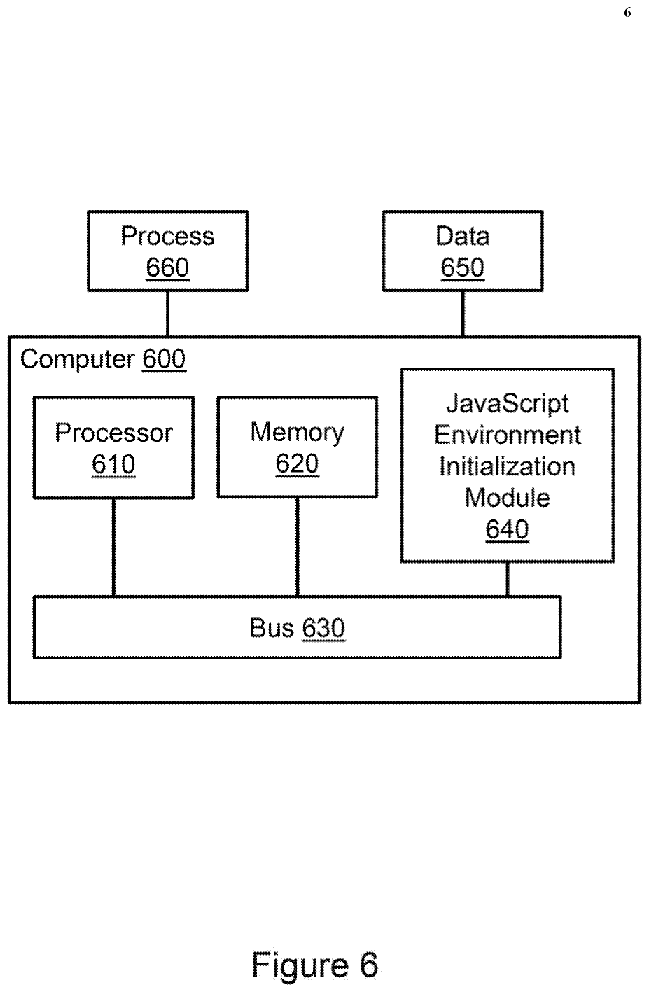

FIG. 6 illustrates an example computing device in which example systems and methods, and equivalents, may operate. The example computing device may be a computer 600 that includes a processor 610 and a memory 620 connected by a bus 630. Computer 600 includes a JavaScript environment initialization module 640. JavaScript environment initialization module 640 may perform, alone or in combination, various functions described above with reference to the example systems, methods, and so forth. In different examples, JavaScript environment initialization module 640 may be implemented as a non-transitory computer-readable medium storing processor-executable instructions, in hardware, as an application specific integrated circuit, and/or combinations thereof.

The instructions may also be presented to computer 600 as data 650 and/or process 660 that are temporarily stored in memory 620 and then executed by processor 610. The processor 610 may be a variety of processors including dual microprocessor and other multi-processor architectures. Memory 620 may include non-volatile memory (e.g., read-only memory, flash memory, memristor) and/or volatile memory (e.g., random access memory). Memory 620 may also be, for example, a magnetic disk drive, a solid state disk drive, a floppy disk drive, a tape drive, a flash memory card, an optical disk, and so on. Thus, memory 620 may store process 660 and/or data 650. Computer 600 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
create a JavaScript environment (JSE) by initializing a portion of a JavaScript virtual machine (JSVM) to a point at which the portion of the JSVM has a known consistent state;
receiving a request for an asset that incorporates the JSVM from an application; and
transmitting the JSE to the application.

2. The method of claim 1, comprising transmitting the application a customized runtime monitor that supports injecting the JSE.

3. The method of claim 1, comprising controlling the application to inject the initialized JSE into a local runtime monitor using an interface of the local runtime monitor.

4. The method of claim 1, comprising transmitting an uninitialized portion of the JSVM to the application.

5. The method of claim 4, where the uninitialized portion of the JSVM is compiled and optimized by a runtime monitor initiated by the application, and where the application incorporates the uninitialized portion and the initialized portion to perform a function.

6. The method of claim 1, repeatedly compiling and executing the portion of the JSVM several times to identify the point at which the portion of the JSVM has the known consistent state.

7. The method of claim 1, where the JSE includes a binary image of a state of the portion of the JSVM including compiled and optimized code, and initialized variables.

8. A system, comprising:
a data store to store a set of uncompiled portions of a JavaScript virtual machine (JSVM);
an optimization module to build portions of the JSVM to identify portions of the JSVM that optimize to a consistent state, and to store initialized versions of the portions of the JSVM that optimize to a consistent state in the data store as JavaScript environments; and
a delivery module to, in response to a request for an asset associated with the JSVM from an application, deliver to a runtime monitor associated with the application, uncompiled portions of the JSVM for portions of the JSVM that are not associated with a JavaScript environment, and JavaScript environments for portions of the JSVM for which a JavaScript environment has been stored.

9. The system of claim 8, where a portion that optimizes to a consistent state is a portion that reaches a reproducible execution point for different input sets for the JSVM.

10. The system of claim 8, where the delivery module also delivers the runtime monitor to the application, and where the runtime monitor delivered to the application supports injecting the JavaScript environments at appropriate locations of the JSVM.

11. The system of claim 8, where the delivery module controls the application to use debugging hooks of a runtime monitor native to the application to inject the JavaScript environments at appropriate locations of the JSVM.

12. The system of claim 8 where the application is a web browser.

13. A non-transitory computer-readable medium storing processor executable instructions that, when executed by a computer, control the computer to:
request an asset associated with a JavaScript virtual machine (JSVM);
receive a JavaScript environment (JSE) associated with a portion of the JSVM, where the JSE is associated with instructions that when optimized, reach a reproducible execution point for different input sets for the JSVM, and where the JSE includes an initialized binary image of a state the portion of the JSVM;
receive an unoptimized portion of the JSVM; and
construct the JSVM by compiling and optimizing the unoptimized portion of the JSVM and injecting the JSE at an appropriate point in the JSVM.

14. The non-transitory computer-readable medium of claim 13, where the instructions further control the computer to receive a runtime monitor that supports injecting the JSE into the JSVM.

15. The non-transitory computer-readable medium of claim 13, where the JSE is injected using debugging hooks associated with a native runtime monitor.
